(19) United States
(12) Patent Application Publication
(10) Pub. No.: US 2023/0065594 A1
(43) Pub. Date: Mar. 2, 2023

(54) SYSTEMS AND METHODS FOR NETWORK TRAFFIC SHAPING

(71) Applicant: Facebook Technologies, LLC, Menlo Park, CA (US)

(72) Inventors: Yee Sin CHAN, San Francisco, CA (US); Kyungho KIM, San Jose, CA (US); Qi QU, Redmond, WA (US); Ping WANG, Redmond, WA (US); Achaleshwar SAHAI, San Jose, CA (US); Chunyu HU, Saratoga, CA (US); Swaminathan BALAKRISHNAN, Los Gatos, CA (US)

(21) Appl. No.: 17/460,467

(22) Filed: Aug. 30, 2021

(51) Int. Cl. H04W 28/02; H04W 76/28; H04L 1/20; H04W 72/12; H04W 72/04

(52) U.S. Cl. CPC H04W 28/0236; H04W 76/28; H04L 1/205; H04W 72/1263; H04W 72/0446

(57) ABSTRACT

Disclosed herein are systems and methods for network traffic shaping and/or adjustment of discontinuous reception (DRX) cycles. A wireless device determines a delay between a time at which a packet is transmitted from a server, to a time of arrival of the packet at the wireless device. The wireless device determines jitter of packets arriving at the wireless device from the server. The wireless device sends a message corresponding to the determined delay and the determined jitter, to the server to perform shaping of packet traffic from the server to the wireless device according to a latency budget of the packet traffic. The wireless device adjusts a length of a discontinuous reception (DRX) cycle of the wireless client device, to align with and to receive the packet traffic shaped by the server.

### FIELD OF DISCLOSURE

The present disclosure is generally related to network traffic shaping for a wireless device including, but not limited to, adjustment of discontinuous reception (DRX) cycles corresponding to the network traffic shaping.

### BACKGROUND

Developments in computing devices and communication devices have prompted growth in mobile and/or wearable technology. Devices may integrate various components in a compact form, such that the devices can be portable yet perform complex processes. For example, a device may be a smart watch that may access content over the network, and may control or communicate with other computing devices, etc. For example, a mobile and/or wearable device may be a head mounted display (HMD) that may present artificial reality (e.g., virtual reality, augmented reality, mixed reality, etc.).

### SUMMARY

Various embodiments disclosed herein are related to methods and systems of traffic shaping and/or DRX cycle adjustment. One implementation of the present disclosure is a method, according to some embodiments. In some embodiments, the method includes determining, by a wireless device, a delay between a time at which a packet is transmitted from a server, to a time of arrival of the packet at the wireless device. In some embodiments, the method includes determining, by the wireless device, jitter of packets arriving at the wireless device from the server. In some embodiments, the method includes sending, by the wireless device, a message corresponding to the determined delay and the determined jitter, to the server to perform shaping of packet traffic from the server to the wireless device according to a latency budget of the packet traffic. In some embodiments, the method includes adjusting, by the wireless device, a length of a discontinuous reception (DRX) cycle of the wireless client device, to align with and to receive the packet traffic shaped by the server.

In some embodiments, the server includes an edge server, a content server, or a content delivery network (CDN) node. In some embodiments, determining the delay includes determining, by the wireless device, a difference between a time-stamp of the packet transmitted from the server, and the time of arrival of the packet at the wireless device.

In some embodiments, the delay includes a time taken for the packet to be communicated from the server across a core network, and across an access point or a base station, to arrive at the wireless device. In some embodiments, the message includes the determined delay and the determined jitter, or includes metrics derived from the determined delay and the determined jitter.

In some embodiments, the method includes causing the server to determine whether the determined delay and the determined jitter exceed a latency budget of the packet traffic. In some embodiments, the method includes causing the server to, when the latency budget is not exceeded, at least one of schedule packets into a smaller number of time slots, or increase a gap between adjacent pairs of the time slots. In some embodiments, the method includes causing the server to, when the latency budget is exceeded, at least one of schedule packets into a larger number of time slots, or decrease a gap between adjacent pairs of the time slots.

In some embodiments, the method includes increasing, by the wireless device, the length of the DRX cycle to align with at least one of the smaller number of time slots, or the increased gap between adjacent pairs of the time slots. In some embodiments, the method includes decreasing, by the wireless device, the length of the DRX cycle to align with at least one of the larger number of time slots, or the decreased gap between adjacent pairs of the time slots.

In some embodiments, the method includes determining, by the wireless device, whether the determined delay and the determined jitter exceed a latency budget of the packet traffic. In some embodiments, the method includes determining, when the latency budget is not exceeded, to send the message to the server to at least one of schedule packets into a smaller number of time slots, or increase a gap between adjacent pairs of the time slots. In some embodiments, the method includes determining, when the latency budget is exceeded, to send the message to the server to at least one of: schedule packets into a larger number of time slots, or decrease a gap between adjacent pairs of the time slots. In some embodiments, the method adjusting, by the wireless device, the length of the DRX cycle according to a latency budget of the packet traffic, the determined delay, and the determined jitter.

Another implementation of the present disclosure is a wireless device including at least one processor, according to some embodiments. In some embodiments, the at least one processor is configured to determine a delay between a time at which a packet is transmitted from a server, to a time of arrival of the packet at the wireless device. In some embodiments, the at least one processor is configured to determine jitter of packets arriving at the wireless device from the server. In some embodiments, the at least one processor is configured to generate a message corresponding to the determined delay and the determined jitter, to the server to perform shaping of packet traffic from the server to the wireless device according to a latency budget of the packet traffic. In some embodiments, the at least one processor is configured to adjust a length of a discontinuous reception (DRX) cycle of the wireless client device, to align with and to receive the packet traffic shaped by the server.

In some embodiments, the server is an edge server, a content server, or a content delivery network (CDN) node. In some embodiments, the at least one processor is configured to determining the delay by determining a difference between a time-stamp of the packet transmitted from the server, and the time of arrival of the packet at the wireless device.

In some embodiments, the delay includes a time taken for the packet to be communicated from the server across a core network, and across an access point or a base station, to arrive at the wireless device. In some embodiments, the message includes the determined delay and the determined jitter, or includes metrics derived from the determined delay and the determined jitter.

In some embodiments, the at least one processor is configured to cause the server to determine whether the determined delay and the determined jitter exceed a latency budget of the packet traffic. In some embodiments, the at least one processor is configured to cause the server to, when the latency budget is not exceeded, at least one of schedule packets into a smaller number of time slots, or increase a gap between adjacent pairs of the time slots. In some embodiments, the at least one processor is configured to cause the server to, when the latency budget is exceeded, at least one of schedule packets into a larger number of time slots, or decrease a gap between adjacent pairs of the time slots.

In some embodiments, the at least one processor is configured to increase the length of the DRX cycle to align with at least one of the smaller number of time slots, or the increased gap between adjacent pairs of the time slots. In some embodiments, the at least one processor is configured to decrease the length of the DRX cycle to align with at least one of the larger number of time slots, or the decreased gap between adjacent pairs of the time slots.

In some embodiments, the at least one processor is configured to determine whether the determined delay and the determined jitter exceed a latency budget of the packet traffic. In some embodiments, the at least one processor is configured to determine, when the latency budget is not exceeded, to send the message to the server to at least one of schedule packets into a smaller number of time slots, or increase a gap between adjacent pairs of the time slots. In some embodiments, the at least one processor is configured to determine, when the latency budget is exceeded, to send the message to the server to at least one of schedule packets into a larger number of time slots, or decrease a gap between adjacent pairs of the time slots. In some embodiments, the at least one processor is configured to adjust the length of the DRX cycle according to a latency budget of the packet traffic, the determined delay, and the determined jitter.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including a mobile and/or wearable device, according to some embodiments.

FIG. 2 is a diagram of a mobile and/or wearable device, according to some embodiments.

FIG. 3 is a diagram showing a perspective view of a head wearable display, according to some embodiments.

FIG. 4 is a block diagram of a computing environment according to some embodiments.

FIG. 5 is a block diagram of a wireless network, according to some embodiments.

FIG. 6 is a diagram illustrating DRX cycle adjustment to match network traffic, according to some embodiments.

FIG. 7 is a diagram illustrating differently shaped traffic for a network and correspondingly adjusted DRX cycles of a device of the network, according to some embodiments.

FIG. 8 is a flow diagram of a process for performing network shaping and DRX adjustment, according to some embodiments.

### DETAILED DESCRIPTION

### Overview

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are embodiments related to a wireless communications system. This disclosure is directed to systems and methods for adjusting discontinuous reception (DRX) cycles of a device and shaping traffic of a network on which the device communicates. The network traffic shaping can be performed at the device or can be performed on a server side application layer (e.g., by a server). The network traffic shaping and DRX cycle adjustment can be particularly advantageous for an edge computing architecture, or for different data traffic types such as video data that can be generated by or used by an augmented reality (AR), virtual reality (VR), mixed reality (MR) device, etc.

The device and the network may have a latency budget based on a type of data to be transmitted via the network. For example, if the device is transmitting video data, less latency may be allowed and the latency budget may be lower, so that the adjustments to the traffic shaping and/or DRX cycle adjustment do not disrupt proper user experience at the device.

The device can communicate with the network to obtain one or more statistics or parameters used to determine adjustments to the DRX cycle and/or to shape the traffic. The one or more statistics can include an end-to-end delay time, and a packet inter-arrival time. The end-to-end delay time is a measure of an amount of delay that occurs when a packet is transmitted from the device to a traffic shaping agent on the network, a server on the network, etc., or vice versa. The packet inter-arrival time is a measure of an uncertainty or jitter of the end-to-end delay time. The end-to-end delay time and the packet inter-arrival time can be used by the device or by the traffic shaping agent to determine adjustments to the DRX cycle and/or the traffic shaping in combination with the latency budget.

A comparison between the latency budget and the end-to-end delay time can be used to identify feasibility of DRX cycle adjustments and/or traffic shaping. If the latency budget is greater than the end-to-end delay time by a sufficient amount (e.g., an amount required to perform the DRX cycle adjustments or the traffic shaping), this indicates feasibility of DRX cycle adjustments or traffic shaping. If the end-to-end delay time, or the packet inter-arrival time (or combination thereof) when compared to the latency budget does not indicate a sufficient amount of time for DRX cycle adjustments or traffic shaping, this may indicate that DRX cycle adjustments/increase or traffic shaping is currently infeasible and should be avoided, or that the DRX cycle should be reduced to thereby increase a frequency that the device transitions into an active state and communicates (e.g., sends and/or receives packets) on the network.

If the comparison between the latency budget and the end-to-end delay time indicates there is sufficient room in terms of latency to adjust/increase the DRX cycle and shape traffic to reduce power consumption at the device (while accounting for the inter-arrival time or uncertainty/jitter of the end-to-end delay time), the DRX cycle can be increased (thereby decreasing a frequency that the device sends/receives packets on the network and reducing power consumption by the device), and one or more packets can be aggregated or grouped (for each longer DRX cycle). The aggregated packets can be transmitted (e.g., sent or received) via the network when the device transitions into an active state according to the adjusted DRX cycle. In this way, the DRX cycle can be increased, and the packets aggregated and transmitted across the network to facilitate power conservation at the device, without disrupting the user experience at the device. Therefore, if the comparison between the latency budget and the end-to-end delay time indicates room (e.g., if the latency budget is greater than the end-to-end delay time by a sufficient amount, accounting for the uncertainty of the end-to-end delay time), packets or groups of packets can be aggregated, and periodicity of transmission can be increased. On the other hand, if the comparison between the latency budget and the end-to-end delay time indicates insufficient room, (e.g., if the end-to-end delay time is at or near the latency budget), the packets can be segmented into smaller packets and/or more clusters/groups of packets (corresponding to a shorter DRX cycle), and the periodicity of packet transmission may be decreased.

Although various embodiments disclosed herein are illustrated with respect to mobile and/or wearable devices, principles disclosed herein can be applied to other handheld devices (e.g., smart phones, tablet computers, laptops, etc.).

### System Architecture

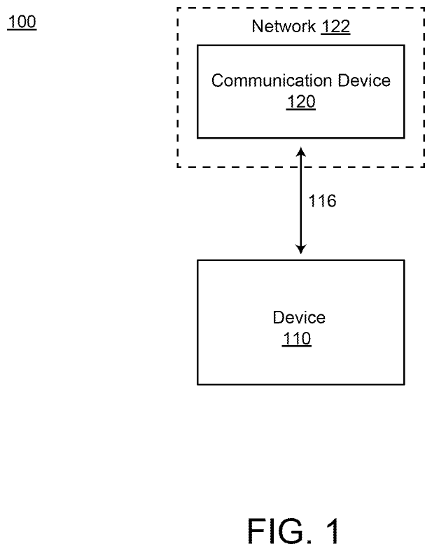

FIG. 1 is a block diagram of an example system 100. In some embodiments, the system 100 includes a communication device 120, a device 110 (e.g., mobile and/or wearable device). The device 110 may be a smart watch, a head wearable device (HWD), etc., or any other mobile/personal device. In some embodiments, the device 110 is a wireless device. The communication device 120 may be an access point or base station of a network 122 (e.g., a cellular network), or any other communication device. The device 110 may be referred to as, include, or be part of a head mounted display (HMD), head mounted device (HMD), head worn display (HWD), head worn device (HWD), smartphone, cellular device, personal computer device, etc. The device 110 and the communication device 120 may communicate with each other through a communication link 116. Through the wireless link 116, the device 110 may access content (e.g., text, image, audio, video, etc.) from other devices (e.g., via the network 122). The communication link 116 may be a wireless link of any type (e.g., cellular link, Wi-Fi link, Bluetooth link, 60 GHz link, ultra wideband link, etc.). For example, the communication link 116 may conform to the 3G, 4G, 5G, LTE, 60 GHz protocol. In some embodiments, the system 100 includes more, fewer, or different components than shown in FIG. 1. The communication link 116 can be a link that is based on a Bluetooth protocol, a wireless local area network (WLAN) protocol, or an ultra-wideband protocol.

In one aspect, the device 110 and the communication device 120 may operate together to provide/support artificial reality for a user. In one example, the device 110 may detect a location and an orientation of the device 110, and generate a sensor measurement indicating the detected location and orientation of the device 110. The device 110 may transmit the sensor measurement to the communication device 120 through the communication link 116. The communication device 120 may receive the sensor measurement, and may generate or determine a view of the artificial reality corresponding to the detected location and orientation of the device 110. The communication device 120 may generate image data of the determined view of the artificial reality, and transmit the image data to the device 110 through the communication link 116. The device 110 may receive the image data, and can present an image of the artificial reality to a user according to the image data. In one aspect, the process of detecting the location and the orientation of the device 110, and rendering the image to the user should be performed within a frame time (e.g., 11 ms or 16 ms). Any latency between a movement of the user wearing the HWD and an image displayed corresponding to the user movement can cause judder, which may result in motion sickness and can degrade the user experience.

In some embodiments, the device 110 and the communication device 120 are configured to exchange data (e.g., SMS text messages, data, MMS messages, VoIP data, cellular data, cellular data, etc.) directly with each other on a local network via the communication link 116 and/or the network 122 thereof via the links 116 and 118.

Mobile and/or Wearable Device

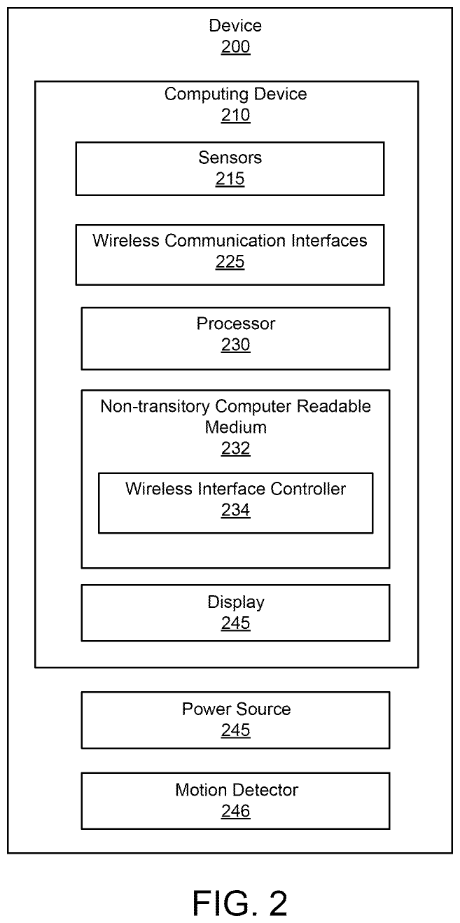

FIG. 2 is a diagram of a device 200 (e.g., mobile and/or wearable device), according to an example implementation of the present disclosure. In some embodiments, the device 110 is the same as or similar to the device 200 as described herein. In some embodiments, the device 200 includes a computing device 210 and a cradle (not shown in FIG. 2), to which the computing device 210 can be selectively attached. In some embodiments, the computing device 210 includes sensors 215, wireless communication interfaces 225 (also referred to as “wireless interfaces 225” herein), processor 230, non-transitory computer readable medium 232, and a display 245. The device 200 also includes a power source 248 (e.g., a battery, a battery cell, Lithium-Ion batteries, a capacitor, an electrical energy storage device, etc.) that is configured to provide electrical energy for the various components of the device 200. The device 200 also includes a motion detector 246 (e.g., a sensor such as an accelerometer, a gyroscope, etc.) that is configured to measure motion of the device 200. These components may operate together to communicate with another device, and generate or render content (e.g., artificial reality content). In other embodiments, the device 200 includes more, fewer, or different components than shown in FIG. 2.

In some embodiments, the sensors 215 include electronic components or a combination of electronic components and software components that detect a proximity of a user wearing the device 200. For example, the sensors 215 can include a hall sensor that can detect whether the user is proximate (e.g., less than 10 mm) to the sensor or whether the user is contacting the computing device 210 (e.g., contacting and/or blocking a certain component of the device used/configured for wireless communication). The sensors 215 may detect a proximity of the user with respect to the computing device 210, and can generate a sensor measurement data indicating the detected proximity.

In some embodiments, the sensors 215 include electronic components or a combination of electronic components and software components that can operate to sense/determine/measure a location, motion/movement and/or an orientation of the computing device 210. Examples of the sensors 255 can include: one or more imaging sensors, one or more accelerometers, one or more gyroscopes, one or more magnetometers, or any other suitable type of sensor(s) that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 215 detect the translational movement and the rotational movement, and determine an orientation and location of the computing device 210. The sensors 215 may generate sensor measurements indicating the detected location and orientation of the computing device 210.

In some embodiments, wireless communication interfaces 225 include electronic components or combinations of electronic components and software components that communicate with another device through wireless communication links (e.g., communication link 114, 116, 118). In some embodiments, the wireless communication interfaces 225 include a wireless interface for a cellular communication link (e.g., 3G, 4G, LTE, 5G, 6G communication link). The wireless communication interfaces 225 may also include a wireless interface for a different communication link (e.g., Wi-Fi or Bluetooth communication link). In some embodiments, wireless communication interfaces 225 include or are embodied as transceivers or communication modems (e.g., a cellular modem) coupled to the transceivers for transmitting and receiving data through wireless mediums. The wireless communication interfaces 225 may transmit or receive sensor measurement data indicating locations and orientations of the computing device 210. Moreover, the wireless communication interface 225 may transmit or receive image data indicating or corresponding to images to be rendered.

In some embodiments, the processor 230 includes an electronic component or a combination of an electronic component that can execute instructions stored by the non-transitory computer readable medium 232. The processor 230 may include one or more central processing units (CPUs), graphical processing units (GPUs) or a combination of them. The non-transitory computer readable medium 232 may store instructions for executing one or more applications executable by the processor 230.

One example application when executed by the processor 230 may cause the processor 230 to generate or process content for rendering. The processor 230 executing the application may cause the processor 230 to generate image data for rendering, according to sensor measurement data from the sensors 215 or the wireless communication interfaces 225. For example, the processor 230 executing the application may determine a view of the artificial reality corresponding to detected location and orientation in the sensor measurement data and generate image data of the determined view of the artificial reality.

In some embodiments, the display 245 is an electronic component that displays an image. The display 245 may, for example, be a liquid crystal display or an organic light emitting diode display. The display 245 may be a touch screen display. The display 245 may be a transparent display that allows the user to see through.

### Head Wearable Device

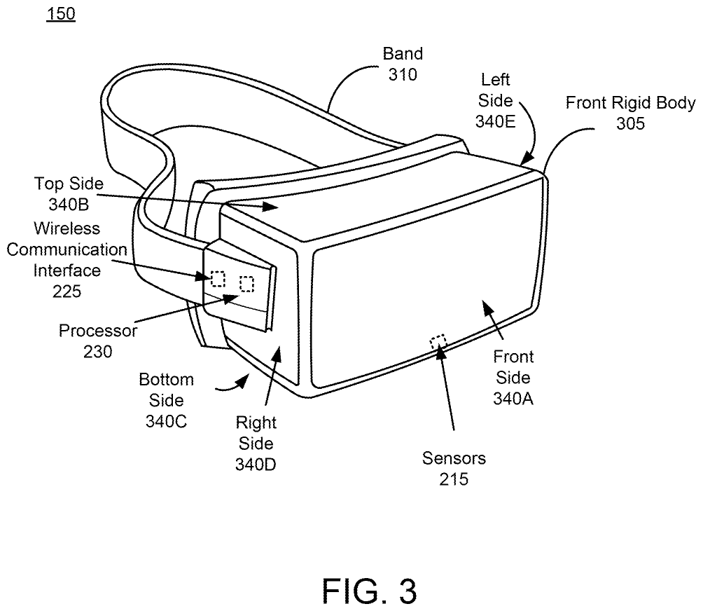

FIG. 3 is a diagram of a device 110, in accordance with an example embodiment. In some embodiments, the device 110 includes a front rigid body 305 and a band 310. The front rigid body 305 includes the display 245 (not shown in FIG. 3), lens (not shown in FIG. 3), the sensors 215, the wireless communication interface 225, and the processor 230. In the embodiment shown by FIG. 3, the wireless communication interface 225, the processor 230, and the sensors 215 are located within the front rigid body 205, and may not be visible to the user. In other embodiments, the device 110 has a different configuration than shown in FIG. 3. For example, the wireless communication interface 225, the processor 230, and/or the sensors 215 may be in different locations than shown in FIG. 3.

### Example System Architecture

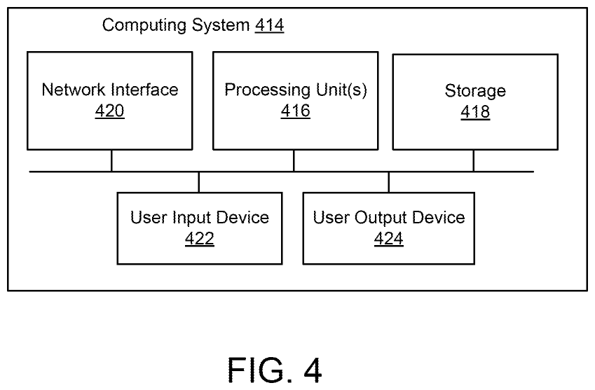

Various operations described herein can be implemented on computer systems. FIG. 4 shows a block diagram of a representative computing system 414 usable to implement the present disclosure. In some embodiments, the device 110 of FIG. 1 is implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

### DRX Cycle Adjustments

Referring particularly to FIGS. 1 and 2, the device 110 is operable in a variety of different modes, according to some embodiments. In some embodiments, the device 110 (and/or its wireless/cellular modem/chip/interface) is operable in a low power mode (LPM) (e.g., a reduced power or sleep mode), a limited service mode, an active mode, or a tethered mode. It should be understood that the modes of the device 110 are not necessarily separate discrete modes and that functionality of the various modes of the device 110 described herein can overlap with each other (e.g., the LPM mode and the limited service mode, or functionality of the device 110 thereof may overlap).

The device 110 can operate according to a discontinuous reception (DRX) cycle, according to some embodiments. In some embodiments, the device 110 is transitionable between a state or mode where data is sent/received (e.g., an active mode or state) and an inactive state or mode where the device 110 is communicably inactive (e.g., except for receiving paging messages, in some embodiments) and does not send and/or receive data (e.g., a sleep mode, an inactive mode, the limited service mode, the LPM mode, etc.). In some embodiments, the device 110 operates according to one or more DRX parameters that defines the behavior of the device 110. In some embodiments, the DRX cycle is one of the DRX parameters. The DRX cycle may be the sum of a duration of ‘On Time’ of the wearable device 110 (e.g., a time duration during which the device 110 is communicably active to send and/or receive communications) and a duration of ‘Off Time’ of the device 110 (e.g., a time duration during which the wearable device 110 is communicably inactive to send and/or receive communications). In some embodiments, the DRX parameters include an on-time duration which defines an amount of time that the device 110 is communicably active. In some embodiments, the DRX parameters also include a DRX-inactivity timer, a DRX retransmission timer, a shortDRX-cycle parameter, and/or a DRXShortCycleTimer.

### Traffic Shaping

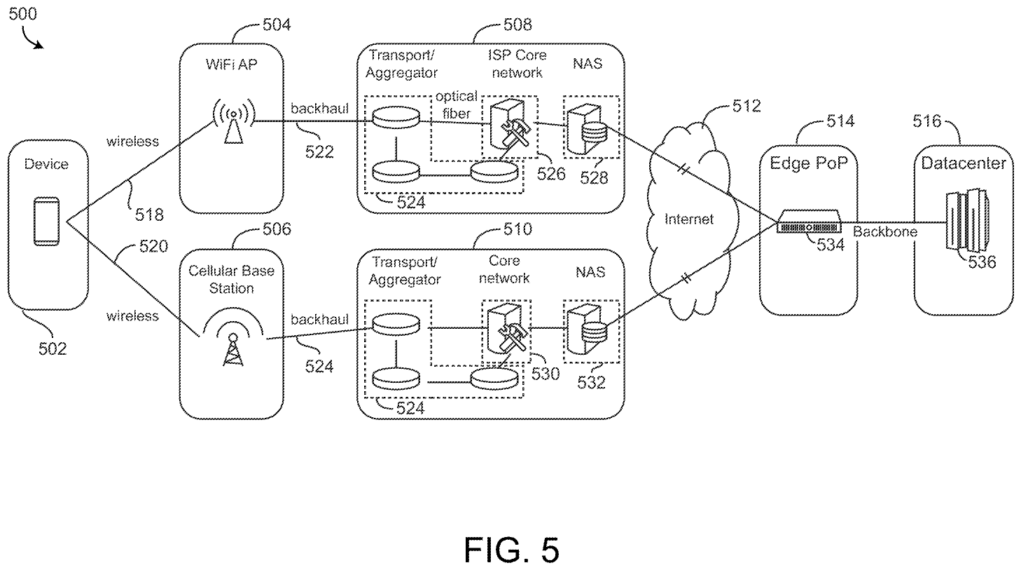

Referring to FIG. 5, a network 500 through which packets, data, traffic, etc., is transmitted includes a device 502, a wireless access point 504, a cellular base station 506, a first gateway 508, and/or a second gateway 510. The device 502 can be the same as or similar to the device 110 as described in greater detail above with reference to FIGS. 1-3. In some embodiments, the device 502 is a user device that is configured to communicate with the Internet 512 via a wireless connection with the wireless access point 504 or the cellular base station 506 (e.g., communication device 120). For example, the device 502 can be configured to communicate with the wireless access point 504 via a wireless link 518, and/or can be configured to communicate with the cellular base station 506 via a wireless link 520. In some embodiments, communication of the device 502 with the cellular base station 506 establishes communication between the wireless device 502 and a cellular network, registers the device 502 on the cellular network, etc. In some embodiments, the device 502 is configured to operate according to a DRX cycle between an active or inactive state, receiving packets, messages, or data while in the active state. The systems and methods described herein can both shape or adjust traffic of the network 500 in combination with cooperatively adjusting the DRX cycle of the device 502 to achieve optimal network performance, power consumption, data transmission, etc., given a latency budget of the network 500.

The wireless access point 504 can be a WiFi access point, according to some embodiments. In some embodiments, the wireless access point 504 is a wireless router that is configured to establish wireless communications between the device 502 and the first gateway 508. In some embodiments, the wireless access point 504 is configured to define a WLAN network, and devices that communicate with the wireless access point 504 are registered and configured as devices on the WLAN. In some embodiments, the cellular base station 506 is a cell tower that is configured to communicate with the device 502 via the wireless link 520. In some embodiments, the wireless links 518 or 520 are the same as or similar to the wireless link 116 as described in greater detail above with reference to FIG. 1.

Referring still to FIG. 5, the first gateway 508 for the wireless access point 504 includes a transport/aggregator 524, an internet service provider (ISP) core network 526, and/or a network applications and services (NAS) 528 (e.g., a server, a proprietary server, network appliance, application functions, etc.), according to some embodiments. The second gateway 510 for the cellular base station 506 can similarly include a transport/aggregator 524, a core network 530, and/or a NAS 532 (e.g., a server, a proprietary server, network appliance, application functions, etc.). In some embodiments, the network application 528 and the network application 532 are the same as or similar to each other and may include one or more processors, processing circuitry, processing circuits, etc. In some embodiments, the network application 528 and/or the network application 532 are configured to perform the traffic shaping techniques described herein for transmission of data packets through the network 500 (e.g., between the device 502 and a server). The transport/aggregators 524 are configured to aggregate data or packets between the local networks defined by the wireless access point 504 and the cellular base station 506 with a global network such as the Internet 512 (e.g., via the ISP core network 526 and the core network 530) according to some embodiments. In some embodiments, the wireless access point 504 is communicably coupled with the first gateway 508, or more specifically, the transport/aggregator 524, through a backhaul cable 522 (e.g., a backhaul Ethernet). Similarly, the cellular base station 506 is communicably coupled with the second gateway 510, or more specifically, the transport/aggregator 524 through a backhaul cable 522 (e.g., a backhaul Ethernet). The transport/aggregator 524 of the first gateway 508 can be connected or communicably coupled with the ISP core network 526 through an optical cable.

In some embodiments, the network applications 528 and 532 are communicably coupled with the ISP core network 526 and the core network 530 between the ISP core network 526 and the core network 530 and the Internet 512 to perform the various traffic shaping techniques described herein. In some embodiments, the device 502 is configured to communicate, through at least one of (i) the wireless access point 504 and the first gateway 508 or (ii) the cellular base station 506 and the second gateway 510, with an edge point of presence (PoP) 514. In some embodiments, the edge PoP 514 is a point of connectivity with a server (e.g., shown as server 534 or server 536 of a datacenter 516). In some embodiments, the network 500 facilitates communications between the device 502 and the server 534 or 536. The device 502 can be configured to exchange packets of data with the server 534 or 536. In some embodiments, the device 502 is configured to transmit packets of video, audio, textual, etc., data to/from the server 534 or 536. The video data can be generated, used by, etc., the device 502 (e.g., an AR device, a VR device, an MR device, etc.), according to some embodiments. In some embodiments, the servers 534 or 536 are or include an edge server, a content server, a content delivery network node (CDN).

In some embodiments, the network 500 has a latency budget, threshold, maximum amount, etc. The latency budget can vary or be based on a type of data transmitted between the device 502 and the server 534 or server 536, architecture of the network 500, specific types of devices or manufacturers of the network 500, etc. In some embodiments, the latency budget indicates a maximum allowable latency or delay of packets through the network 500 that can be used to determine traffic shaping adjustments (e.g., aggregating/grouping data and/or packets of data for transmission through the network 500) and appropriate DRX cycle adjustments for the device 502. Aggregating data and/or packets may mean combining data and/or multiple packets into one (larger) packet (e.g., that aligns with a DRX wake/active time of a receiver). Aggregating/grouping packets may mean scheduling the packets closer to each other and/or within a time window (e.g., to align with a DRX wake/active time of a receiver). In some embodiments, the latency budget is an end-to-end latency budget of the network 500 (e.g., a latency budget associated with latency between the device 502 and a destination of packets such as the servers 534 or 536). For example, if the data transmitted through the network 500 are video data packets, the latency budget may be lower so that adjustments to the traffic of the network 500 and/or the DRX cycle of the device 502 does not disrupt proper user experience at the device 502.

In some embodiments, the device 502 and/or at least one of the network applications 528 or 532 are configured to communicate on the network 500 to obtain one or more statistics or parameters used to shape network traffic and/or to adjust the DRX cycle of the device 502. In some embodiments, the one or more statistics include end-to-end delay time (e.g., an amount of time for a packet to travel from a first point to a second point in the network 500 such as from the device 502 to the edge PoP 514, from the device 502 to the server 534, from the device 502 to the server 536, etc.), and a packet inter-arrival time. In some embodiments, the end-to-end delay time is a measure of an amount of delay or time that occurs when a packet is transmitted from the device 502 to a traffic shaping agent on the network 500 (e.g., the networking application 532), a server on the network 500, etc., or vice versa. In some embodiments, the packet inter-arrival time is a measure of an uncertainty, jitter, variation, standard deviation, etc., of the end-to-end delay time. For example, a packet may be transmitted from a point A to a point B on the network 500 over a time duration Δt=Δt_{ETE}+/−Δtⱼᵢₜₜₑᵣ where Δt is an amount of time for the packet to travel from point A to point B or vice versa, Δt_{ETE} is the end-to-end delay time, and Δtⱼᵢₜₜₑᵣ is the jitter, or an amount of time based on the jitter or uncertainty, according to some embodiments. In some embodiments, traffic shaping is performed (e.g., by the device 502, by a server on the network 500, by a network shaping agent positioned at the server 528 or the server 532 of the network 500, etc.) using the packet inter-arrival time (e.g., the jitter), the end-to-end delay time, and a latency budget or threshold. The DRX cycle of the device 502 can also be adjusted based on the end-to-end delay time, the packet inter-arrival time (e.g., the jitter), and/or the latency budget or threshold, or can be adjusted based on the shaped traffic, according to some embodiments.

In some embodiments, the end-to-end delay time is determined based on timestamps of packets transmitted through the network 500. For example, the device 502, the network application 528, the network application 532, etc., may use transmission and reception timestamps of a packet to determine a difference between a time at which the packet is transmitted from the device 502 and a time at which the packet is received at the network application 528 or the network application 532, or vice versa. In some embodiments, the end-to-end delay time is an amount of time for a packet to be transferred between the device 502 and one of the network applications 528 or 532. For example, the end-to-end delay time may account for delays associated with transmitting the packet from the device 502 to the wireless access point 504 (or to the cellular base station 506), delays associated with transmitting the packet from the access point 504 to the transport/aggregator 524 (or from the cellular base station 506 to the transport/aggregator 524), and delays associated with transferring the packet across the ISP core network 526 to the network application 528 (or across the core network 530 to the network application 532).

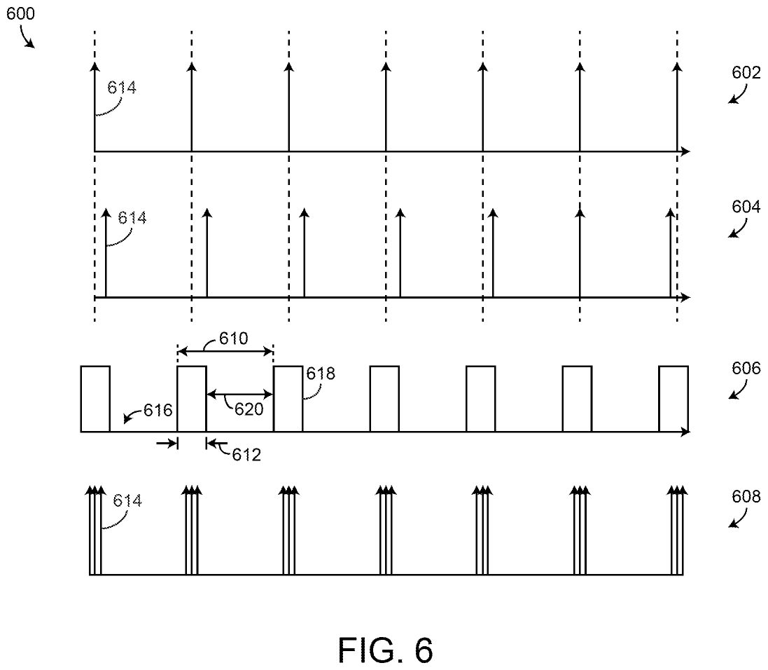

Referring particularly to FIG. 6, a diagram 600 illustrates a DRX adjustment technique that can be performed by the device 502, by the network application 528, by the network application 532, or by the edge device 514, according to some embodiments. Diagram 600 includes a timeseries 602 that illustrates different packets or messages 614 being transmitted or received at the shown times, according to some embodiments. In some embodiments, the packets or messages 614 deviate from the shown times, as shown in timeseries 604. Timeseries 606 shows a DRX cycle of the device 502 transitioning between an inactive mode 616 and an active mode 618, according to some embodiments. In some embodiments, the DRX cycle of the device 502 can be adjusted (e.g., increased or decreased) so that the device 502 is in the active mode 618 at times when the packets or messages 614 are received/transmitted and in the inactive mode 616 for times when the packets or messages 614 are not received/transmitted. In some embodiments, the device 502 is in the on mode 618 (e.g., an on-duration) for a time 612. The DRX cycle may be a complete amount of time 610 from when the device 502 first transitions into the active mode 618, maintains in the on mode 618 for the time 612, transitions into the inactive mode 616, and maintains in the inactive mode 616 until the device 502 is transitioned again into the active mode 619. In some embodiments, the time 612 that the device 502 is in the active mode 618 is a predetermined amount, and adjustments of the DRX cycle include increasing or decreasing the time 610. In some embodiments, adjusting the DRX cycle includes adjusting the time 612 that the device 502 is in the active mode 618, or an amount of time 620 that the device 502 is in the inactive mode 616. As shown in a timeseries 608 of FIG. 6, the times at which packets are transmitted may include transmission of multiple messages or packets 614.

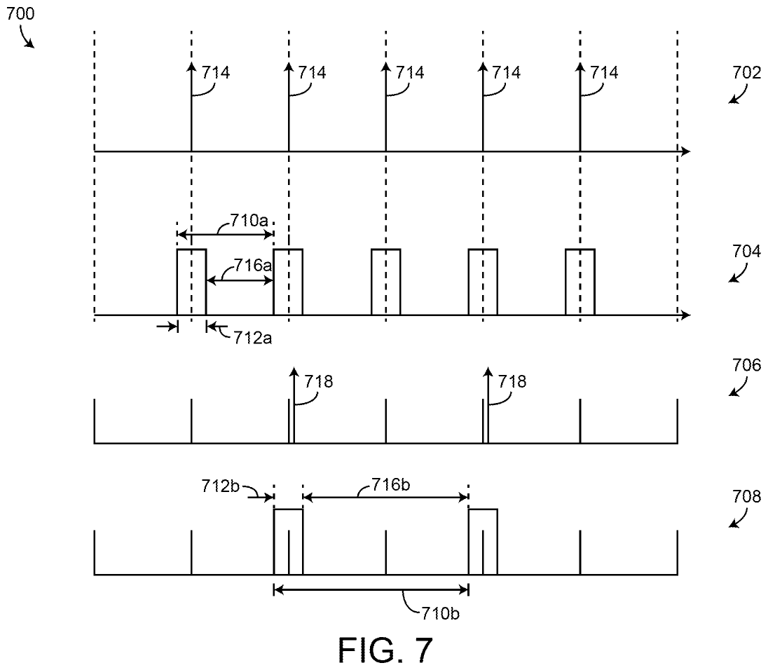

Referring particularly to FIG. 7, a diagram 700 illustrating DRX and traffic shaping adjustments includes a timeseries 702 of packet receptions/transmissions 714, a timeseries 704 of a DRX cycle of the device 502 for the packet receptions/transmissions 714 shown in the timeseries 702, a timeseries 706 showing adjusted traffic of packet receptions/transmissions 718, and a timeseries 708 of a DRX cycle of the device 502 for the packet receptions/transmissions 718 shown in the timeseries 706, according to some embodiments. In some embodiments, the device 502 and the traffic shaping agent of the network 500 are configured to transition the operation of the network 500 (e.g., the receptions/transmissions of the packets and the DRX cycle of the device 502) between the network traffic/DRX cycle as shown in timeseries 702 and 704, and the network traffic/DRX cycle as shown in the timeseries 706 and 708.

The device 502 and the traffic shaping agent of the network 500 (e.g., the network application 528 or the network application 532) can be configured to adjust the traffic of packets and messages of the network 500 and the DRX cycle of the device 502 by scheduling, aggregating, grouping, de-grouping, de-aggregating, etc., the packets into a larger or smaller number of time slots, or by decreasing or increasing a time duration between adjacent or subsequent packet or message (or packet/message group) transmissions, according to some embodiments. In some embodiments, a DRX cycle of the device 502 can be increased from a shorter DRX cycle 710a to a longer DRX cycle 710b in order to account for the differently shaped traffic. Similarly, the DRX cycle of the device 502 can be decreased from the longer DRX cycle 710b to the shorter DRX cycle 710a in order to account for the differently shaped traffic. In some embodiments, an on-time 712 of the device 502 can also be adjusted (e.g., shown as on-time 712a and on-time 712b which may be different). In some embodiments, an off-time 716 of the device 502 can also be adjusted so that the times at which the device 502 is in the active or on mode match time slots at which the packet transmissions 714 or packet transmissions 718 occur.

In some embodiments, the traffic shaping agent (e.g., the network application 528, the network application 532 and/or edge device 514) is configured to compare a current latency amount to a threshold or budget latency to determine if packets should be sent more frequently or less frequently. In some embodiments, the current latency is determined by the traffic shaping agent based on the end-to-end delay time and/or the jitter. If the current latency exceeds the threshold latency, the traffic shaping agent (e.g., located at a server of the network 500) may increase the packet transmissions (e.g., increase a frequency of packet transmissions by de-grouping or de-aggregating packets 718 into packets 714 and transmitting the packets 714 at the increased frequency) over a given time period by scheduling the packets 718 into a larger number of time slots (e.g., the packets 714) and/or by decreasing a gap or time duration between adjacent or subsequent time slots of packets 718. In some embodiments, once the frequency of packet transmission has been increased (e.g., as shown in the timeseries 702 relative to the timeseries 706), the traffic shaping agent or the device 502 may determine proper adjustments for the DRX cycle so that the device 502 transitions into the active mode to transmit or receive packets as shown in timeseries 704 relative to the timeseries 708. In this way, the traffic of the packets can be shaped and the DRX cycle of the device 502 can be subsequently adjusted (e.g., increased or decreased) so that the device 502 is in the active mode when the packets 714 are transmitted.

Similarly, if the current latency does not exceed the threshold or budget latency, the traffic shaping agent may decrease a frequency of packet transmission by aggregating or grouping the packets 714 into a smaller number of time slots, as shown by the packets 718 of the timeseries 706, and/or by increasing a gap between adjacent pairs of timeslots at which the packets 714 are transmitted, according to some embodiments. In some embodiments, once the frequency of packet transmission has been decreased (e.g., as shown in the packets 718 of the timeseries 706 relative to the packets 714 of the timeseries 702), the DRX cycle of the device 502 can be adjusted so that the device 502 is in the on or active mode at times when the packets 718 are received/transmitted and in the off or inactive mode at times when the packets 718 are not received/transmitted. In this way, the DRX cycle of the device 502 can be adjusted to match the traffic shaping for decreased frequency of packets communicated through the network 500.

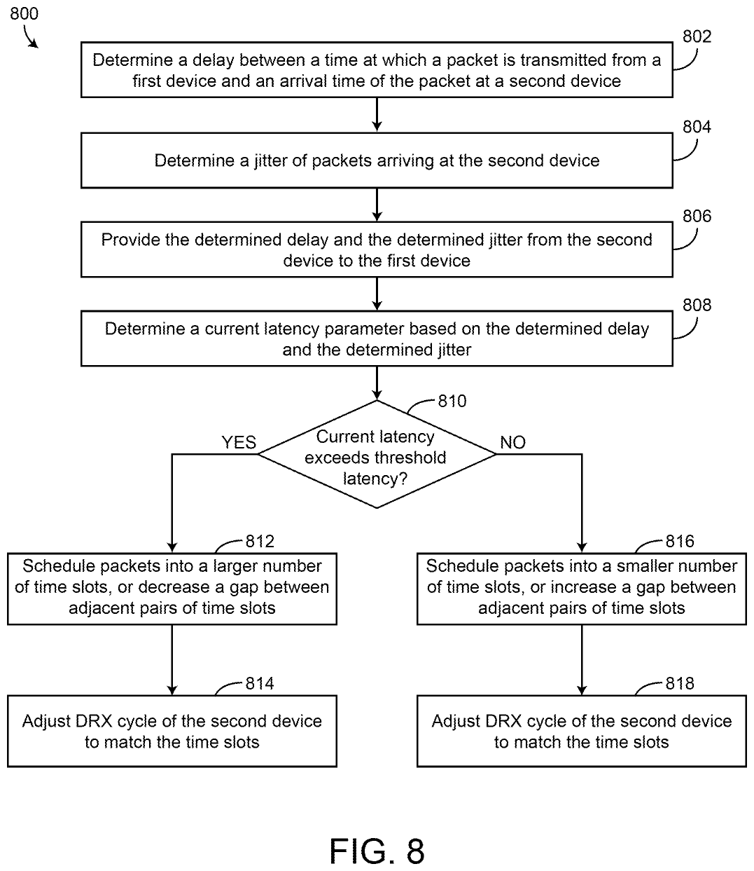

Referring particularly to FIG. 8, a process 800 for performing traffic shaping and/or DRX adjustment of devices on a network is shown, according to some embodiments. In some embodiments, process 800 includes steps 802-818 and is performed by the device 502, by the network application 528, or by the network application 532. In some embodiments, portions of the process 800 directed to the traffic shaping are performed by the network application 528 or the network application 532, while portions of the process 800 directed to the DRX adjustment are performed by the device 502. The process 800 can be performed by one or more processors, processing circuits, processing circuitry, etc., of the device 502, the network application 528, the network application 532 and/or the edge device 514.

Process 800 includes determining a delay between a time at which a packet is transmitted from a first device and an arrival time of the packet at a second device (step 802), according to some embodiments. In some embodiments, the delay is the end-to-end delay time as described in greater detail above with reference to FIG. 5. In some embodiments, the delay is determined based on timestamps (e.g., reception and transmission timestamps) of one or more packets. For example, the delay may be a difference between the time at which the packet is transmitted from the first device and the arrival time of the packet at the second device. The first device may be the device 502 (e.g., a wireless device) and the second device may be a server of the network 500 (e.g., the network applications 528 or 532, the edge device 514, a server, a CDN node, etc.). In some embodiments, the delay accounts for or includes time delays associated with transferring the packet to or from a wireless access point or cell tower (e.g., a cellular base station), transporting or aggregating the packet, transferring the packet through a core network, etc. In some embodiments, the delay is determined by reception of a message or transfer of a message through the network that includes the delay. Step 802 and/or some of the other steps may be performed by the device 502 and/or by a server of the network 500 (e.g., the network applications 528 or 532, the edge device 514), according to some embodiments.

Process 800 includes determining a jitter of packets arriving at the second device (step 804), according to some embodiments. In some embodiments, the jitter is received as a message or is included in a packet. In some embodiments, the jitter is the packet inter-arrival time as described in greater detail above with reference to FIG. 5. In some embodiments, the jitter is determined by monitoring a number of different packet transmissions over time and determining a variation, uncertainty, etc., of the delay based on the packet transmissions. In some embodiments, the jitter is provided as the packet inter-arrival time with reception of the packet. In some embodiments, step 804 is performed by the device 502.

Process 800 includes providing the determined delay and the determined jitter from the second device to the first device (step 806), according to some embodiments. In some embodiments, step 806 includes sending a message from the second device to the first device including the determined delay and the determined jitter for traffic shaping. In some embodiments, step 806 is performed by the device 502. For example, the device 502 can transmit the determined delay and the determined jitter to the network applications 528, the network application 532 and/or the edge device 514 for use in traffic shaping of the network 500.

Process 800 includes determining a current latency parameter based on the determined delay and the determined jitter (step 808), according to some embodiments. In some embodiments the current latency parameter is an estimation of a current amount of latency or time delay of the network (e.g., the network 500) that incorporates both the determined delay and the determined jitter. In some embodiments, the current latency parameter is an estimation of a maximum expected latency of the network. For example, the current latency can be a sum of the delay and the jitter to estimate a maximum latency that may occur on the network. Step 808 may be performed by the first device using the determined delay and the determined jitter as provided by the second device, according to some embodiments. In some embodiments, step 808 is performed by a server of the network 500, an edge server of the network 500, a content server of the network 500, or a CDN node of the network 500. In some embodiments, step 808 is performed by the edge device 514, the network applications 528 and/or the network application 532.

Process 800 includes determining if the current latency exceeds a threshold or budget latency (step 810), according to some embodiments. In some embodiments, step 810 includes comparing the current latency parameter of the network (e.g., the network 500) to a maximum allowable or budget latency (e.g., the threshold latency). In some embodiments, step 810 is performed by the server of the network 500. For example, step 810 can be performed by a traffic shaping agent at a server of the network 500 such as by the edge device 514, the network applications 528 or the network application 532. If the current latency exceeds the threshold latency (step 810, “YES”), process 800 proceeds to step 812. If the current latency does not exceed the threshold latency (step 810, “NO”), process 800 proceeds to step 816.

Process 800 includes scheduling (e.g., spreading, distributing, grouping, partitioning, clustering, arranging, batching) packets into a larger number of time slots, or decreasing a gap between adjacent pairs of time slots (step 812) in response to the current latency exceeding the threshold latency (step 810, “YES”), according to some embodiments. In some embodiments, step 812 is performed by the traffic shaping agent at the server of the network 500 (e.g., by the edge device 514, the network applications 528 or the network application 532). In some embodiments, step 812 includes transitioning or shaping the network traffic from the network traffic as shown in timeseries 706 and 708 of FIG. 7 to the network traffic as shown in timeseries 702 and 704 of FIG. 7. In some embodiments, the packets are scheduled, aggregated, grouped, de-grouped, de-aggregated, etc., into a larger or increased number of time slots so that packets are transmitted more frequently over a given time period. Similarly, a time duration between adjacent or subsequent times or time slots at which packets are transmitted may be decreased so that the number or frequency of packet transmission over a given time period is increased, according to some embodiments. Advantageously, increasing the frequency of packet transmission when the current latency is greater than the latency threshold allows for improved performance and transmission of packets through the network.

Process 800 includes adjusting a DRX cycle of the second device to match the time slots that are shaped in step 812 (step 814), according to some embodiments. In some embodiments, step 814 is performed by the traffic shaping agent that performs the step 812 (e.g., by the edge device 514, the network application 528 and/or the network application 532). In some embodiments, step 814 includes adjusting the DRX cycle of the second device (e.g., the device 502, a user device, a wireless device, etc.) so that the second device is in an active or on mode when the packets are scheduled/expected for reception/transmission, and an off or inactive mode for times when the packets are not scheduled/expected for reception/transmission. In some embodiments, step 814 is performed at the second device. In some embodiments, the second device is configured to receive an updated schedule of traffic shaping or packet transmissions from the first device and update its DRX cycle based on the updated schedule of traffic shaping or packet transmissions. In some embodiments, the DRX adjustments are determined by the first device, and a message including the updates are provided to the second device for implementation or appropriate adjustment of the DRX cycle at the second device. Step 814 may include decreasing the DRX cycle so that the second device is in the on or active mode more frequently and matches with the larger number of time slots or the decreased gap between the adjacent pairs of time slots, according to some embodiments.

Process 800 includes scheduling (e.g., distributing, grouping, partitioning, clustering, arranging, aggregating, batching) the packets into a smaller number of time slots, or increasing a gap between adjacent pairs of time slots (step 816) in response to the current latency exceeding the threshold latency (step 810, “NO”), according to some embodiments. In some embodiments, step 816 is performed by the traffic shaping agent at the server of the network 500 (e.g., by the edge device 514, the network application 528 or the network application 532). In some embodiments, step 816 includes transitioning or shaping the network traffic from the network traffic as shown in timeseries 702 and 704 of FIG. 7 to the timeseries 706 and 708 as shown in FIG. 7. In some embodiments, the packets are scheduled, aggregated, grouped, de-grouped, de-aggregated, etc., into a smaller or decreased number of time slots so that packets are transmitted less frequently over a given time period. Similarly, a time duration between adjacent or subsequent times or time slots at which packets are transmitted may be increased so that the number or frequency of packet transmission over a given time period is decreased, according to some embodiments. Advantageously, decreasing the packet transmissions when the current latency is less than the threshold latency allows for improved performance and transmission of packets through the network and/or energy efficiency at the second device.

Process 800 includes adjusting the DRX cycle of the second device to match the time slots (step 818), according to some embodiments. In some embodiments, step 818 is similar to step 814. In some embodiments, step 818 is performed by the traffic shaping agent that performs the step 816 (e.g., by the edge device 514, the network application 528 and/or the network application 532). In some embodiments, step 818 includes adjusting the DRX cycle of the second device (e.g., the device 502, a user device, a wireless device, etc.) so that the second device is in an active or on mode when the packets are scheduled/expected for reception/transmission, and an off or inactive mode for times when the packets are not scheduled/expected for reception/transmission. In some embodiments, step 818 is performed at the second device. In some embodiments, the second device is configured to receive an updated schedule of traffic shaping or packet transmissions from the first device and update its DRX cycle based on the updated schedule of traffic shaping or packet transmissions. In some embodiments, the DRX adjustments are determined by the first device, and a message including the updates are provided to the second device for implementation or appropriate adjustment of the DRX cycle at the second device. Step 818 may include increasing the DRX cycle so that the second device is in the on or active mode less frequently and matches with the larger number of time slots or the decreased gap between the adjacent pairs of time slots, according to some embodiments.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
determining, by a wireless device, a delay between a time at which a packet is transmitted from a server, to a time of arrival of the packet at the wireless device;
determining, by the wireless device, jitter of packets arriving at the wireless device from the server;
sending, by the wireless device, a message corresponding to the determined delay and the determined jitter, to the server to perform shaping of packet traffic from the server to the wireless device according to a latency budget of the packet traffic; and
adjusting, by the wireless device, a length of a discontinuous reception (DRX) cycle of the wireless client device, to align with and to receive the packet traffic shaped by the server.

2. The method of claim 1, wherein the server comprises an edge server, a content server, or a content delivery network (CDN) node.

3. The method of claim 1, wherein determining the delay comprises:
determining, by the wireless device, a difference between a time-stamp of the packet transmitted from the server, and the time of arrival of the packet at the wireless device.

4. The method of claim 1, wherein the delay comprises a time taken for the packet to be communicated from the server across a core network, and across an access point or a base station, to arrive at the wireless device.

5. The method of claim 1, wherein the message includes the determined delay and the determined jitter, or includes metrics derived from the determined delay and the determined jitter.

6. The method of claim 1, comprising:
causing the server to determine whether the determined delay and the determined jitter exceed a latency budget of the packet traffic;
causing the server to, when the latency budget is not exceeded, at least one of: schedule packets into a smaller number of time slots, or increase a gap between adjacent pairs of the time slots; and
causing the server to, when the latency budget is exceeded, at least one of: schedule packets into a larger number of time slots, or decrease a gap between adjacent pairs of the time slots.

7. The method of claim 6, comprising:
increasing, by the wireless device, the length of the DRX cycle to align with at least one of: the smaller number of time slots, or the increased gap between adjacent pairs of the time slots.

8. The method of claim 6, comprising:
decreasing, by the wireless device, the length of the DRX cycle to align with at least one of: the larger number of time slots, or the decreased gap between adjacent pairs of the time slots.

9. The method of claim 1, comprising:
determining, by the wireless device, whether the determined delay and the determined jitter exceed a latency budget of the packet traffic;
determining, when the latency budget is not exceeded, to send the message to the server to at least one of: schedule packets into a smaller number of time slots, or increase a gap between adjacent pairs of the time slots; and
determining, when the latency budget is exceeded, to send the message to the server to at least one of: schedule packets into a larger number of time slots, or decrease a gap between adjacent pairs of the time slots.

10. The method of claim 1, comprising:
adjusting, by the wireless device, the length of the DRX cycle according to a latency budget of the packet traffic, the determined delay, and the determined jitter.

11. A wireless device, comprising:
at least one processor configured to:
determine a delay between a time at which a packet is transmitted from a server, to a time of arrival of the packet at the wireless device;
determine jitter of packets arriving at the wireless device from the server;
generate a message corresponding to the determined delay and the determined jitter, to the server to perform shaping of packet traffic from the server to the wireless device according to a latency budget of the packet traffic; and
adjust a length of a discontinuous reception (DRX) cycle of the wireless client device, to align with and to receive the packet traffic shaped by the server.

12. The wireless device of claim 11, wherein the server comprises an edge server, a content server, or a content delivery network (CDN) node.

13. The wireless device of claim 11, wherein the at least one processor is configured to determining the delay by determining a difference between a time-stamp of the packet transmitted from the server, and the time of arrival of the packet at the wireless device.

14. The wireless device of claim 11, wherein the delay comprises a time taken for the packet to be communicated from the server across a core network, and across an access point or a base station, to arrive at the wireless device.

15. The wireless device of claim 11, wherein the message includes the determined delay and the determined jitter, or includes metrics derived from the determined delay and the determined jitter.

16. The wireless device of claim 11, wherein the at least one processor is configured to:
cause the server to determine whether the determined delay and the determined jitter exceed a latency budget of the packet traffic;
cause the server to, when the latency budget is not exceeded, at least one of: schedule packets into a smaller number of time slots, or increase a gap between adjacent pairs of the time slots; and
cause the server to, when the latency budget is exceeded, at least one of: schedule packets into a larger number of time slots, or decrease a gap between adjacent pairs of the time slots.

17. The wireless device of claim 16, wherein the at least one processor is configured to:
increase the length of the DRX cycle to align with at least one of: the smaller number of time slots, or the increased gap between adjacent pairs of the time slots.

18. The wireless device of claim 16, wherein the at least one processor is configured to:
decrease the length of the DRX cycle to align with at least one of: the larger number of time slots, or the decreased gap between adjacent pairs of the time slots.

19. The wireless device of claim 11, wherein the at least one processor is configured to:
determine whether the determined delay and the determined jitter exceed a latency budget of the packet traffic;
determine, when the latency budget is not exceeded, to send the message to the server to at least one of: schedule packets into a smaller number of time slots, or increase a gap between adjacent pairs of the time slots; and
determine, when the latency budget is exceeded, to send the message to the server to at least one of: schedule packets into a larger number of time slots, or decrease a gap between adjacent pairs of the time slots.

20. The wireless device of claim 11, wherein the at least one processor is configured to: adjust the length of the DRX cycle according to a latency budget of the packet traffic, the determined delay, and the determined jitter.
